(19) United States
(12) Patent Application Publication
(10) Pub. No.: US 2020/0056317 A1
(43) Pub. Date: Feb. 20, 2020

(54) DAMPING DEVICE FOR A WASHING MACHINE, AND WASHING MACHINE

(71) Applicant: QINGDAO HAIER WASHING MACHINE CO., LTD., Shandong (CN)

(72) Inventors: Peishi LV, Shandong (CN); Lin YANG, Shandong (CN); Gangjin ZHANG, Shandong (CN); Yun TIAN, Shandong (CN); Chunxia ZHOU, Shandong (CN)

(73) Assignee: QINGDAO HAIER WASHING MACHINE CO., LTD., Shandong (CN)

(21) Appl. No.: 16/348,596

(22) PCT Filed: Nov. 10, 2017
(86) PCT No.: PCT/CN2017/110451

§ 371 Date: May 9, 2019

(30) Foreign Application Priority Data
Nov. 10, 2016 (CN) 201610986554.2

(51) Int. Cl. D06F 37/24; F16F 13/00

(52) U.S. Cl. CPC D06F 37/24; F16F 13/005

(57) ABSTRACT

A damping device for a washing machine and a washing machine are provided. The damping device for a washing machine comprises a damping suspension rod, an upper bracket, a damping spring and a sliding damping support seat; an upper end of the damping suspension rod is installed on a cabinet of the washing machine, the upper bracket is installed on an outer tub of the washing machine, and the damping suspension rod passes through the upper bracket, the sliding damping support seat and the damping spring in sequence from top to bottom; and the sliding damping support seat is provided with a variable damping structure for transferring an eccentric force to generate a sliding damping acting on the damping suspension rod when the outer tub shakes or swings.

### TECHNICAL FIELD

The present disclosure relates to the technical field of damping of a washing machine, in particular to a damping device for a washing machine and a washing machine.

### BACKGROUND

When the automatic washing machine starts dehydration process and operates dehydration process, an outer tub will shake or swing along with the motor starting, resulting in greater vibration and noise. Therefore, in order to weaken vibration and noise of the washing machine during dehydration, the existing automatic washing machines are generally provided with a damping device. One end of the damping device is hoisted on a cabinet of the washing machine, while the other end is suspended on a hanging seat of an outer tub of the washing machine. The damping device is internally provided with a damping spring, and when the outer tub shakes or swings, the damping device relieves the eccentricity of the outer tub through the buffering effect of the damping spring to achieve the purpose of damping. However, along with the development of the washing machine, when the eccentricity of the washing machine is large, if only the damping effect of a damping spring is relied on, shaking and swinging of the outer tub cannot be effectively prevented.

Some of the damping devices of the existing washing machine are only provided with a damping spring, and are mostly applied to small-capacity washing machines. For some damping devices, a sliding damping structure is additionally added on the basis of the damping spring. However, the provided sliding damping force is too small, thereby being incapable of playing an effect of damping and noise reduction. Still for some damping devices, a friction rubber piece is added between the sliding damping support seat and the upper bracket, however, such a structure is high in cost and poor in reliability, and after long-term abrasion, the friction damping force will disappear gradually.

In view of this, the present disclosure is hereby proposed.

### SUMMARY

In order to solve the above problem, the first inventive objective of the present disclosure is to provide a damping device for a washing machine, in particular, the following technical solution is adopted:

A damping device for a washing machine includes a damping suspension rod, an upper bracket, a damping spring and a sliding damping support seat, wherein an upper end of the damping suspension rod is installed on a cabinet of the washing machine, the upper bracket is installed on an outer tub of the washing machine, and the damping suspension rod passes through the upper bracket, the sliding damping support seat and the damping spring in sequence from top to bottom; and

the sliding damping support seat is provided with a variable damping structure for transferring an eccentric force to generate a sliding damping acting on the damping suspension rod when the outer tub shakes or swings.

As a preferred implementation of the present disclosure, the variable damping structure includes an inclined structure and a deformation damping structure, the inclined structure transfers an eccentric force to the deformation damping structure, and the deformation damping structure deforms to generate a sliding damping acting on the damping suspension rod;

preferably, the sliding damping support seat comprises an annular body arranged at one end of the sliding damping support seat and multiple elastomers which are respectively connected with the annular body, the annular body is against to the upper bracket, the elastomers extend into the damping spring, and a through hole is formed by the multiple elastomers and is located in a center to allow the damping suspension rod to pass through;

the upper bracket is exerted an eccentric force generated by shaking or swinging of the outer tub of the washing machine, and the inclined structure of the sliding damping support seat transfers the eccentric force to each elastomer, and each elastomer is tightened to increase the sliding damping on the damping suspension rod; and

the upper bracket is released by shaking or swinging of the outer tub of the washing machine, and each of the elastomers is loosened to reduce or completely release the sliding damping on the damping suspension rod.

As a preferred implementation of the present disclosure, the elastomers are distributed at equal intervals along circumference of the annular body; a first part of each of the elastomers connected with the annular body is obliquely disposed to form the inclined structure,

or the inclined structure is an inclined rib for connecting the elastomer and the annular body.

As a preferred implementation of the present disclosure, each of the elastomers comprises an inclined section and a vertical section, and a first end of the inclined section is connected with the annular body, a second end of the inclined section is inclined towards an inner side of the annular body; and the vertical section is connected with the inclined section and arranged in a vertical direction; and

an inner wall of the vertical section of each of the elastomers protrudes inwardly and is in contact with the damping suspension rod to generate a sliding damping on the damping suspension rod.

As a preferred implementation of the present disclosure, a first end of the inclined rib is connected with the annular body, a second end of the inclined rib is inclined towards an inner side of the annular body and connected with the elastomers, and the elastomers are arranged in a vertical direction; and

an inner wall of each of the elastomers protrudes inwardly and is in contact with the damping suspension rod to generate a sliding damping on the damping suspension rod.

As a preferred implementation of the present disclosure, several of the inclined ribs are provided, and the inclined ribs and the elastomers are in a one-to-one corresponding relationship along circumference of the annular body.

As a preferred implementation of the present disclosure, an outer wall of an intersection between the inclined section and the vertical section of each elastomer is provided with a blocking rib, all blocking ribs form an annular blocking rib, and an upper end of the damping spring and is against the annular blocking rib;

or, an outer wall of an intersection between each inclined rib and each elastomer is provided with a blocking rib, all blocking ribs form an annular blocking rib, and an upper end of the damping spring is against the annular blocking rib.

As a preferred implementation of the present disclosure, a reinforcing rib is arranged between the blocking rib and an outer wall of the inclined section of each of the elastomers;

or a reinforcing rib is arranged between the blocking rib and an outer wall of the inclined rib.

As a preferred implementation of the present disclosure, the damping device further comprises a damping pad, the damping pad is between the upper bracket and the sliding damping support seat, the damping suspension rod passes through the damping pads.

A second inventive objective of the present disclosure is to provide a washing machine, specifically, the following technical solution is adopted:

A washing machine having the damping device for a washing machine mentioned in anyone of the above items is provided.

The damping device for a washing machine in the present disclosure is provided with a sliding damping support seat which is designed separately, and the sliding damping support seat can use general plastic materials, therefore, the manufacturing cost is low.

The sliding damping support seat of the present disclosure is provided with an inclined structure which can effectively transfer the force applied by an outer tub. Along with the shaking or swinging of the outer tub, the upper bracket and the sliding damping support seat will slide up and down along the damping suspension rod, and the damping spring will be compressed or released.

When the outer tub shakes or swings to put downwards an eccentric force on the upper bracket, the damping spring is compressed, and the sliding damping support seat is tightened and is in friction with the damping suspension rod to generate a damping force. When the outer tub shakes or swings to release the pressure on the upper bracket, the damping spring is elongated, and the sliding damping support seat is released, then the friction between the sliding damping support seat and the damping suspension rod is gradually reduced, the generated sliding friction damping force is reduced or completely released, and each part of the damping device is reset.

Therefore, the damping device for a washing machine of the present disclosure is provided with a sliding damping support seat. When the dehydration process of the washing machine is started and operated, friction between the sliding damping support seat and the damping suspension rod provides a sliding damping force to the outer tub, thereby effectively reducing shaking and swinging of the outer tub, playing a favorable damping effect, and enabling the washing machine to keep quiet and stable dehydration starting and operation.

The washing machine provided with the damping device for the washing machine of the present disclosure can keep quiet and stable dehydration starting and operation.

### BRIEF DESCRIPTION OF THE DRAWINGS

FIG. 1 is an exploded view of a damping device for a washing machine of the present disclosure;

FIG. 2 is a sectional view of a damping device for a washing machine of the present disclosure;

FIG. 3 is a first schematic diagram of a three-dimensional structure of a sliding damping support seat of the damping device for a washing machine in the present disclosure;

FIG. 4 is a second schematic diagram of a three-dimensional structure of a sliding damping support seat of the damping device for a washing machine in the present disclosure;

FIG. 5 is a sectional view of a sliding damping support seat of a damping device for a washing machine in the present disclosure.

Reference numerals in the figures: 100—gasket 200—suspension rod seat 300—damping suspension rod 400—upper bracket 500—damping pad 600—sliding damping support seat 601—annular body 602—inclined structure 603—reinforcing rib 604—blocking rib 605—elastic clearance 606—elastomer 700—damping spring 800—lower bracket.

### DETAILED DESCRIPTION

A detailed description will be given below on a damping device for a washing machine and a washing machine of the present disclosure in combination with accompanying drawings:

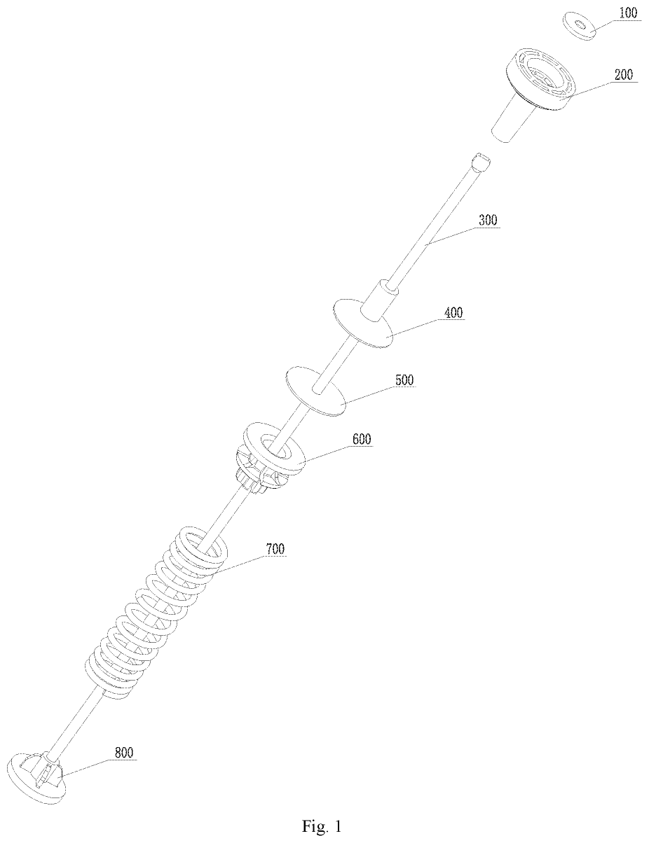

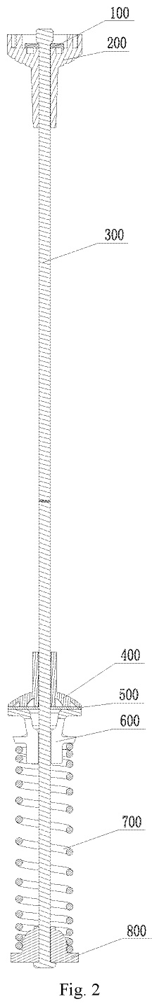

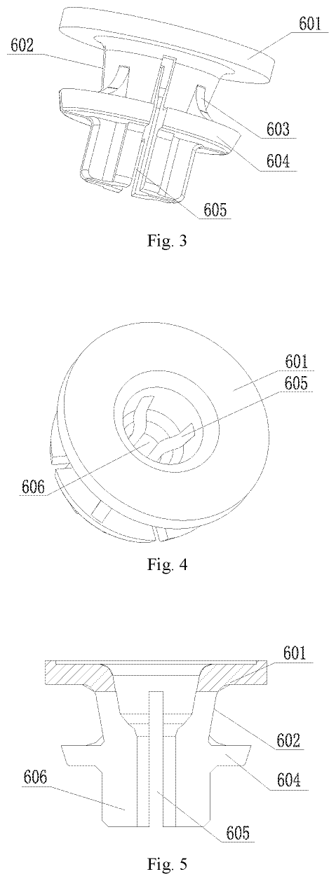

As shown in FIG. 1 to FIG. 5, a damping device for a washing machine in the present embodiment comprises a damping suspension rod 300, an upper bracket 400, a damping spring 700 and a sliding damping support seat 600. An upper end of the damping suspension rod 300 is installed on a cabinet of a washing machine. The upper bracket 400 is installed on an outer tub of the washing machine, and the damping suspension rod 300 passes through the upper bracket 400. The sliding damping support seat 600 and the damping spring 700 in sequence from top to bottom. And the sliding damping support seat 600 is provided with a variable damping structure for transferring an eccentric force to generate a sliding damping acting on the damping suspension rod 300 when the outer tub shakes or swings.

Preferably, the variable damping structure of the present embodiment includes an inclined structure 602 and a deformation damping structure. The inclined structure 602 transfers an eccentric force to the deformation damping structure, and the deformation damping structure deforms to generate a sliding damping acting on the damping suspension rod.

The sliding damping support seat 600 of the present embodiment is provided with an inclined structure 602 which can effectively transfer the force applied by the outer tub. Along with the shaking or swinging of the outer tub, the upper bracket 400 and the sliding damping support seat 600 will slide up and down along the damping suspension rod 300, and the damping spring 700 will be compressed or released. Preferably, in order that the inclined structure 602 can effectively transfer the eccentric force, generated by shaking or swinging of the outer tub, to a deformable part of the sliding damping support seat 600 and offer a sliding damping for the damping suspension rod, so as to realize a favorable damping effect. Therefore, the inclined structure 602 of the present embodiment inclines towards a direction close to the damping suspension rod 300 from top to bottom of the damping suspension rod 300, such that an eccentricity component during compression generates a component force along a horizontal direction to act on a deformable part of the sliding damping support seat 600 and the sliding damping support seat is tightened to generate a sliding damping force.

When the outer tub shakes or swings to exert downwards an eccentric force to the upper bracket 400, the damping spring 700 is compressed, the sliding damping support seat 600 is tightened and is in friction with the damping suspension rod 300 to generate a damping force. When the outer tub shakes or swings to release the pressure on the upper bracket, the damping spring 700 is elongated, and the sliding damping support seat 600 is released, then the friction with the damping suspension rod 300 is gradually reduced. The generated sliding friction damping force is reduced or completely released, and each part of the damping device is reset.

Therefore, the damping device for a washing machine of the present embodiment is provided with a sliding damping support seat 600. When the dehydration process of the washing machine is started and operated, friction between the sliding damping support seat 600 and the damping suspension rod 300 provides a sliding damping force to the outer tub, thereby effectively reducing shaking and swinging of the outer tub, playing a favorable damping effect, and enabling the washing machine to keep quiet and stable dehydration starting and operation.

Therefore, the damping device for a washing machine in the present embodiment is provided with a sliding damping support seat 600 which is designed separately, then a favorable sliding friction damping role can be put on the damping suspension rod 300, thereby improving damping effect of the washing machine. The sliding damping support seat 600 of the present embodiment can be used separately to satisfy damping requirements of general washing machines, or can be matched with the sliding damping block to further enhance the effect of sliding damping, so as to acquire a better damping effect and accommodate to washing machines of a larger specification. In addition, the sliding damping support seat 600 of the present embodiment can be made of ordinary plastic materials, therefore, the manufacturing cost is low and the service life is long.

In order to realize that the sliding damping support seat 600 of the present embodiment can change the magnitude of the sliding damping on the damping suspension rod 300 along with the shaking or swinging of the outer tub. Specifically, the sliding damping support seat 600 of the present embodiment comprise an annular body 601 arranged at one end and multiple elastomers 606 which are respectively connected with the annular body 601. The annular body 601 is against to the upper bracket 400. The elastomers 606 extend into the damping spring 700, and a through hole is formed by the multiple elastomers and is located in a center to allow the damping suspension rod 300 to pass through.

The upper bracket 400 is exerted an eccentric force generated by shaking or swinging of the outer tub of the washing machine, and the damping spring 700 is compressed, then the inclined structure 602 of the sliding damping support seat 600 transfers an eccentric force to each elastomer 606. And each elastomer 606 is tightened to increase the sliding damping on the damping suspension rod 300.

The upper bracket is released by shaking or swinging of the outer tub of the washing machine, then the damping spring 700 is elongated, and each of the elastomers 606 is loosened to reduce or completely release the sliding damping on the damping suspension rod 300.

An elastic clearance 605 is formed by elastomers 606 of the present embodiment. When the outer tub does not shake or swing, an inner wall of the elastomer is in contact with the damping suspension rod 300, but no extrusion friction occurs or the extrusion friction force is not large. When the outer tub shakes or swings, the elastomer 606 is tightened under the effect of an eccentric force transferred by the inclined structure 602, and the inner wall of the elastomer 606 is in close contact with the damping suspension rod 300 and the extrusion friction generates a larger sliding friction damping to slow down shaking or swinging of the outer tub and realize the effect of damping.

Preferably, four elastomers 606 of the present embodiment are available. Four elastomers 606 enclose a circle and an elastic clearance 605 is provided between adjacent elastomers 606.

Specifically, the elastomers 606 of the present embodiment are distributed at equal intervals along circumference of the annular body 601. A first part of the elastomers 606 connected with the annular body 601 is obliquely disposed to form the inclined structure 602. Or, the inclined structure 602 is an inclined rib for connecting the elastomers 606 and the annular body 601.

The inclined structure 602 of the present embodiment is inclined towards the center of the annular body 601, in this way, the whole sliding damping support seat 600 tends to be gradually reduced from the annular body 601 to the elastomer 606. The sliding damping support seat 600 of the present embodiment can be molded in one body, and can also be formed by connecting each part together.

Specifically, the deformation damping structure of the present embodiment is an elastomer or a vertical section of the elastomer.

As a preferred implementation of the present embodiment, each of the elastomers 606 comprises an inclined section and a vertical section, and a first end of the inclined section is connected with the annular body, a second end of the inclined section is inclined towards an inner side of the annular body; and the vertical section is connected with the inclined section and arranged in a vertical direction. And an inner wall of the vertical section of each of the elastomers 606 protrudes inwardly and is in contact with the damping suspension rod to generate a sliding damping on the damping suspension rod. The elastomer 606 and the inclined structure 602 of the present embodiment are molded in one body, the inclined section of each of the elastomer 606 is the inclined structure 602, and the vertical section is the deformed part which is in contact with the damping suspension rod 300 to generate a sliding friction damping.

As a preferred implementation of the present embodiment, a first end of the inclined rib is connected with the annular body 601, a second end of the inclined rib is inclined towards an inner side of the annular body 601 and connected with the elastomer 606, and the elastomers 606 are arranged in a vertical direction. An inner wall of each of the elastomer 606 protrudes inwardly and is in contact with the damping suspension rod 300 to generate a sliding damping on the damping suspension rod. The inclined rib of the present embodiment and the annular body 601 can be molded in one body, and the elastomer 606 is fixedly connected with the inclined rib. In this way, the elastomer 606 can be made of rubber materials with a higher damping coefficient, and elastomers 606 of corresponding specifications can be selected according to requirements to satisfy requirements of sliding damping.

In the present embodiment, the inclined rib includes several, and the inclined ribs and the elastomers 606 are in a one-to-one corresponding relationship along circumference of the annular body 601.

Further, in the present embodiment, an outer wall of an intersection between the inclined section and the vertical section of each elastomer 606 is provided with a blocking rib 604. All blocking ribs 604 form an annular blocking rib, and an upper end of the damping spring 700 is abutted against the annular blocking rib.

Or, an outer wall of an intersection between each inclined rib and each elastomer 606 is provided with a blocking rib 604, all blocking ribs 604 form an annular blocking rib, and an upper end of the damping spring 700 is abutted against the annular blocking rib.

The sliding damping support seat 600 of the present embodiment is arranged between the upper bracket 400 and the damping spring 700, the annular body 601 of the sliding damping support seat 600 is abutted against the upper bracket 400. When the upper bracket 400 bears an eccentric force of the outer tub, the eccentric force can directly act on the sliding damping support seat 600, and the sliding damping support seat 600 is also provided with an annular blocking rib which is configured to be against the damping spring 700. In this way, part of the eccentric force of the outer tub can directly act on the damping spring 700 through the sliding damping support seat 600, and the damping spring 700 is compressed to provide a damping elastic force, and another part of eccentric force acts on the elastomer 606 through an inclined structure, and the elastomer 606 is in friction with the damping suspension rod 300 to generate a sliding friction damping. Therefore, the sliding damping support seat 600 of the present embodiment has a favorable damping effect aiming at shaking and swinging of the outer tub of a washing machine.

As a preferred implementation of the present disclosure, a reinforcing rib 603 is set between the blocking rib 604 and an outer wall of the inclined section of the elastomer 606. Or a reinforcing rib 603 is set between the blocking rib 604 and an outer wall of the inclined rib. The reinforcing rib 603 can enhance overall strength of the sliding damping support seat 600, therefore, a favorable abrasion performance is possessed, and the service life is prolonged.

As a preferred implementation of the present disclosure, the damping device for a washing machine of the present embodiment further includes damping pads 500. The damping pad 500 is arranged between the upper bracket 400 and the sliding damping support seat 600, and the damping suspension rod 300 passes through the damping pads 500 in sequence. The cooperation between the damping pad 500 and the sliding damping support seat 600 can further enhance sliding damping effect of the damping device for a washing machine, and a better damping performance is possessed.

Specifically, the damping pad 500 of the present embodiment can be a sheet structure, therefore, the manufacturing is simple and the cost is low. The damping pad 500 is made of materials with a favorable damping performance, such as rubber.

The damping device for a washing machine in the present embodiment further includes a suspension rod seat 200 which is fixedly installed on an upper end of the damping suspension rod 300, and the suspension rod seat 200 is hoisted on an upper part of a cabinet of the washing machine. A gasket 100 is additionally added between the suspension rod seat 200 and the cabinet of the washing machine to enhance the damping effect.

The damping device for a washing machine of the present embodiment further includes a lower bracket 800 which is fixedly installed on a lower end of the damping suspension rod 300, and the lower end of the damping spring 700 ends at and is abutted against the lower bracket 800.

Meanwhile, the present embodiment provides a washing machine provided with the damping device for a washing machine as mentioned in any one of the above items. The washing machine provided with the above damping device for a washing machine in the present disclosure can keep quiet and stable dehydration starting and operation.

The above descriptions are merely preferred embodiments of the present disclosure, rather than a limitation to the present disclosure in any form. Although the present disclosure is disclosed above through the preferred embodiments, however, the present disclosure is not limited hereto. Those skilled in the art can make some changes or modify to equivalent embodiments with equivalent changes by utilizing the technical contents enlightened above under the premise of not departing from the scope of the technical solution of the present disclosure. As long as the contents do not depart from the technical solution of the present disclosure, any simple alterations, equivalent changes and modifications made to the above embodiments according to the technical essence of the present disclosure shall still fall within the scope of the solution of the present disclosure.

1. A damping device for a washing machine, comprising a damping suspension rod, an upper bracket, a damping spring and a sliding damping support seat, wherein:
an upper end of the damping suspension rod is installed on a cabinet of the washing machine, the upper bracket is installed on an outer tub of the washing machine, and the damping suspension rod passes through the upper bracket, the sliding damping support seat and the damping spring in sequence from top to bottom; and
the sliding damping support seat is provided with a variable damping structure for transferring an eccentric force to generate a sliding damping acting on the damping suspension rod when the outer tub shakes or swings.

2. The damping device for a washing machine according to claim 1, wherein the variable damping structure comprises an inclined structure and a deformation damping structure;
the inclined structure transfers an eccentric force to the deformation damping structure, and the deformation damping structure deforms to generate a sliding damping acting on the damping suspension rod.

3. The damping device for a washing machine according to claim 2, wherein the elastomers are distributed at equal intervals along circumference of the annular body; a first part of each of the elastomers connected with the annular body is obliquely disposed to form the inclined structure,
or, the inclined structure is an inclined rib for connecting the elastomers and the annular body.

4. The damping device for a washing machine according to claim 2, wherein each of the elastomers comprises an inclined section and a vertical section, and a first end of the inclined section is connected with the annular body, a second end of the inclined section is inclined towards an inner side of the annular body; and the vertical section is connected with the inclined section and arranged in a vertical direction; and
an inner wall of the vertical section of each of the elastomers protrudes inwardly and is in contact with the damping suspension rod to generate a sliding damping on the damping suspension rod.

5. The damping device for a washing machine according to claim 2, wherein a first end of the inclined rib is connected with the annular body, a second end of the inclined rib is inclined towards an inner side of the annular body and connected with the elastomers, and the elastomers are arranged in a vertical direction; and
an inner wall of each of the elastomers protrudes inwardly and is in contact with the damping suspension rod to generate a sliding damping on the damping suspension rod.

6. The damping device for a washing machine according to claim 5, wherein several of the inclined ribs are provided, and
the inclined ribs and the elastomers are in a one-to-one corresponding relationship along circumference of the annular body.

7. The damping device for a washing machine according to claim 3, wherein an outer wall of an intersection between the inclined section and the vertical section of each elastomer is provided with a blocking rib, all blocking ribs form an annular blocking rib, and an upper end of the damping spring is against the annular blocking rib;
or, an outer wall of an intersection between each inclined rib and each elastomer is provided with a blocking rib, all blocking ribs form an annular blocking rib, and an upper end of the damping spring is against the annular blocking rib.

8. The damping device for a washing machine according to claim 7, wherein a reinforcing rib is arranged between the blocking rib and an outer wall of the inclined section of each of the elastomers;
or a reinforcing rib is arranged between the blocking rib and an outer wall of the inclined rib.

9. The damping device for a washing machine according to claim 1, further comprising a damping pad, the damping pad is between the upper bracket and the sliding damping support seat, the damping suspension rod passes through the damping pads.

10. A washing machine provided with the damping device for a washing machine according to claim 1.

11. The damping device for a washing machine according to claim 2, wherein the sliding damping support seat comprises an annular body arranged at one end of the sliding damping support seat and multiple elastomers respectively connected with the annular body; the annular body is against to the upper bracket, the elastomers extend into the damping spring, and a through hole is formed by the multiple elastomers and is located in a center to allow the damping suspension rod to pass through;
the upper bracket is exerted an eccentric force generated by shaking or swinging of the outer tub of the washing machine, and the inclined structure of the sliding damping support seat transfers the eccentric force to each elastomer, and each elastomer is tightened to increase the sliding damping on the damping suspension rod; and
the upper bracket is released by shaking or swinging of the outer tub of the washing machine, and each of the elastomers is loosened to reduce or completely release the sliding damping on the damping suspension rod.

12. The damping device for a washing machine according to claim 3, wherein each of the elastomers comprises an inclined section and a vertical section, and a first end of the inclined section is connected with the annular body, a second end of the inclined section is inclined towards an inner side of the annular body; and the vertical section is connected with the inclined section and arranged in a vertical direction; and
an inner wall of the vertical section of each of the elastomers protrudes inwardly and is in contact with the damping suspension rod to generate a sliding damping on the damping suspension rod.

13. The damping device for a washing machine according to claim 3, wherein a first end of the inclined rib is connected with the annular body, a second end of the inclined rib is inclined towards an inner side of the annular body and connected with the elastomers, and the elastomers are arranged in a vertical direction; and
an inner wall of each of the elastomers protrudes inwardly and is in contact with the damping suspension rod to generate a sliding damping on the damping suspension rod.

14. The damping device for a washing machine according to claim 4, wherein an outer wall of an intersection between the inclined section and the vertical section of each elastomer is provided with a blocking rib, all blocking ribs form an annular blocking rib, and an upper end of the damping spring is against the annular blocking rib;
or, an outer wall of an intersection between each inclined rib and each elastomer is provided with a blocking rib, all blocking ribs form an annular blocking rib, and an upper end of the damping spring is against the annular blocking rib.

15. The damping device for a washing machine according to claim 5, wherein an outer wall of an intersection between the inclined section and the vertical section of each elastomer is provided with a blocking rib, all blocking ribs form an annular blocking rib, and an upper end of the damping spring is against the annular blocking rib;
or, an outer wall of an intersection between each inclined rib and each elastomer is provided with a blocking rib, all blocking ribs form an annular blocking rib, and an upper end of the damping spring is against the annular blocking rib.

16. The damping device for a washing machine according to claim 6, wherein an outer wall of an intersection between the inclined section and the vertical section of each elastomer is provided with a blocking rib, all blocking ribs form an annular blocking rib, and an upper end of the damping spring is against the annular blocking rib;
or, an outer wall of an intersection between each inclined rib and each elastomer is provided with a blocking rib, all blocking ribs form an annular blocking rib, and an upper end of the damping spring is against the annular blocking rib.

17. The damping device for a washing machine according to claim 2, further comprising a damping pad, the damping pad is between the upper bracket and the sliding damping support seat, the damping suspension rod passes through the damping pads.

18. The damping device for a washing machine according to claim 3, further comprising a damping pad, the damping pad is between the upper bracket and the sliding damping support seat, the damping suspension rod passes through the damping pads.

19. The damping device for a washing machine according to claim 4, further comprising a damping pad, the damping pad is between the upper bracket and the sliding damping support seat, the damping suspension rod passes through the damping pads.

20. The damping device for a washing machine according to claim 5, further comprising a damping pad, the damping pad is between the upper bracket and the sliding damping support seat, the damping suspension rod passes through the damping pads.
